(19) United States
(12) Patent Application Publication
(10) Pub. No.: US 2017/0103009 A1
(43) Pub. Date: Apr. 13, 2017

(54) MONITORING A DEVICE STATUS FOR AN APPLICATION

(71) Applicant: MICROSOFT TECHNOLOGY LICENSING, LLC, Redmond, WA (US)

(72) Inventors: NIKET ASHOK SANGHVI, SEATTLE, WA (US); SAMUEL DAVID ADAMS, BELLEVUE, WA (US); BENJAMIN SCOTT MCGREGOR, REDMOND, WA (US)

(21) Appl. No.: 14/881,974

(22) Filed: Oct. 13, 2015

(51) Int. Cl. G06F 11/30

(52) U.S. Cl. CPC G06F 11/3051; G06F 11/3006

(57) ABSTRACT

The technology described herein provides a mechanism to monitor a status of external devices on behalf of applications running on a computing device. In one aspect, a monitoring application running on a computing device receives monitoring requests from multiple applications on the computing device. Each monitoring request can provide device details for an external device to be monitored and specific relationship status that defines when a notification should be sent to the application associated with the monitoring request. When the current relationship status corresponds to the specific relationship status for a device matching the device details, then a notification can be sent to the application. The individual application does not need to actively monitor a device status and can remain in an inactive state while monitoring is ongoing.

### BACKGROUND

Applications on computing devices, such as personal computers, tablets, smartphones, augmented reality headwear, virtual reality headwear, game consoles, etc., increasingly connect to external devices and perform tasks that drive larger scenarios. These applications need to find external devices in range, connect to them, and sometimes complete a data exchange with the external devices. Traditionally, individual applications can monitor for the status of external devices. The monitoring is either done when applications are in use or done by applications running “in the background” while the user may or may not be using the computing device for other tasks.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The technology described herein provides a mechanism to monitor a status of external devices on behalf of applications running on a computing device. In one aspect, a monitoring application running on a computing device receives monitoring requests from multiple applications on the computing device. Each monitoring request can provide device details for an external device to be monitored and a specific relationship status with the external device that should trigger when a notification should be sent to the application that provided the monitoring request. When the current relationship status corresponds to the specified relationship status for a device matching the device details, then a notification can be sent to the application. The individual application does not need to actively monitor a device status and can remain in an inactive state while monitoring is ongoing.

The technology described herein can reduce power consumption and conserve computing resources. Allowing multiple applications on a single device to perform similar monitoring functions (e.g., to search for and connect to external devices) on their own cadence is inefficient from a power consumption and processing standpoint. In some cases, the same application may need to perform different monitoring operations multiple times for different protocols or different external devices. This becomes especially true when applications often do not find the devices they are looking for. Furthermore, some applications may perform external device monitoring inefficiently by not taking advantage of certain protocol efficiencies regarding power consumption or hardware offloading during a monitoring process. Applications on the single device may be looking for and connecting to similar external devices, and allowing a single monitoring application to perform the monitoring operations can conserve power and computing resources by enabling the process to be performed only once.

### BRIEF DESCRIPTION OF THE DRAWINGS

Aspects of the technology described in the present application are described in detail below with reference to the attached drawing figures, wherein:

FIG. 1 is a block diagram of an exemplary application environment suitable for implementing aspects of the technology described herein;

FIG. 2 is a diagram depicting an exemplary computing environment within a user device comprising a monitoring application, in accordance with an aspect of the technology described herein;

FIG. 3 is a diagram depicting a method of monitoring an external device status on behalf of multiple applications installed on the computing device, in accordance with an aspect of the technology described herein;

FIG. 4 is a diagram depicting a method for monitoring an external device status on behalf of multiple applications installed on the computing device, in accordance with an aspect of the technology described herein;

FIG. 5 is a diagram depicting a method of monitoring an external device status on behalf of multiple applications installed on the computing device, in accordance with an aspect of the technology described herein; and

FIG. 6 is a block diagram of an exemplary computing environment suitable for implementing aspects of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein provides a mechanism to monitor a status of external devices on behalf of applications running on a computing device. In one aspect, a monitoring application running on a computing device receives monitoring requests from multiple applications on the computing device. Each monitoring request can provide device details for an external device to be monitored and a specific relationship status with the external device that should trigger when a notification should be sent to the application that provided the monitoring request. The device details act as a filter criterion to identify a specific device or device types to be monitored on a behalf of an application. The specific relationship status identifies a property to be monitored. When the current relationship status corresponds to the specified relationship status for a device matching the device details, then a notification can be sent to the application. The individual application does not need to actively monitor a device status and can remain in an inactive state while monitoring is ongoing.

The technology described herein can reduce power consumption and conserve computing resources. Allowing multiple applications on a single device to perform similar monitoring functions (e.g., to search for and connect to external devices) on their own cadence is inefficient from a power consumption and processing standpoint. In some cases, the same application may need to perform different monitoring operations multiple times for different protocols or different external devices. This becomes especially true when applications often do not find the devices they are looking for. Furthermore, some applications may perform external device monitoring inefficiently by not taking advantage of certain protocol efficiencies regarding power consumption or hardware offloading during a monitoring process. Applications on the single device may be looking for and connecting to similar external devices and allowing a single monitoring application to perform the monitoring operations can conserve power and computing resources by enabling the process to be performed only once.

For example, when one monitoring program monitors device relationships instead of multiple programs it uses resources better because the monitoring application can coalesce many similar device discovery requests into one. For example, without using the technology described herein, N applications can look for Bluetooth® devices. The one monitoring application can do a single Bluetooth discovery on behalf of all N applications, then funnel the results from the one query to all applications according to application needs as expressed in monitoring requests. When a single monitoring application is performing monitoring functions instead of each application then one process is running instead of N processes. The monitoring application can use special internal operating system resources not available to third party applications to control its own process lifetime efficiently, to control radios, to coordinate resource usage between protocols like Bluetooth® and Wi-Fi Direct®, for example, and to efficiently handle hardware offload.

Having briefly described an overview of aspects of the technology described herein, an exemplary operating environment suitable for use in implementing the technology is described below.

### Exemplary Application Environment

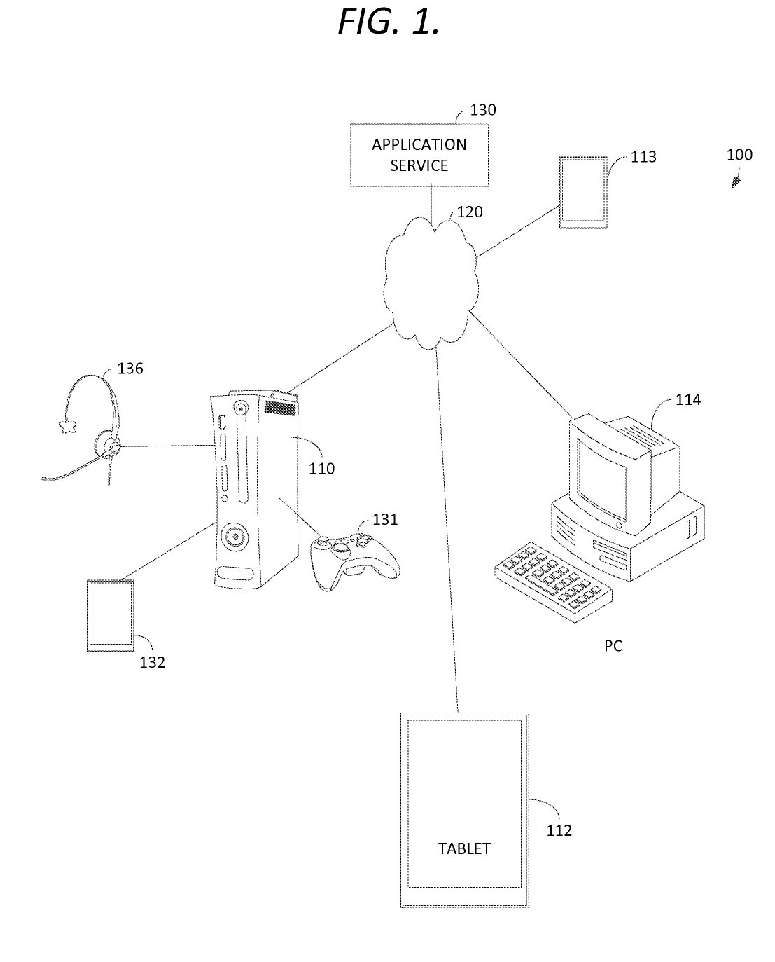

Turning now to FIG. 1, an monitoring environment 100 is shown, in accordance with an aspect of the technology described herein. The monitoring environment 100 includes multiple devices that could use a monitoring application to determine the device's status with other devices in the monitoring environment 100. Upon detecting a connection event, a presence event, a disconnect event, or some other status event, the monitoring application can notify other applications on the device that a registered event has occurred. A registered event is an event that an application requests notification for.

The monitoring environment 100 comprises various user devices connected to each other through a network 120 or directly through either a wired or a wireless connection. Exemplary user devices connected to the network include a game console 110, a tablet 112, a smartphone 113, and a personal computer 114. Use of other user devices, such as augmented reality glasses, storage devices, keyboards, and such, are also possible.

The game console 110 may have one or more devices communicatively coupled to it directly through either a wired or a wireless connection. The directly connected devices include a headset 136, gamepad 131, and a smartphone 132.

Network 120 may be a local area network, for example, provided by a wireless router (not shown) located in a home, apartment, business, or other location. Other types of networks are possible, for example transports/topologies: Personal Area Network (PAN) (like in Bluetooth), Mesh networks like ZigBee IEEE 802.11.15, Internet (cloud) based virtual devices or real devices whose IO is remoted over the Internet, and Switched networks. Devices connected to the network 120 may communicate with each other in some circumstances. The various devices shown could have monitoring applications that determine when a device is connected to another device. Upon making that determination, the monitoring application could notify one or more applications on the device.

Smartphone 132 is shown coupled directly to the game console 110, but the connection could be indirect through the Internet or a subnet. In addition to being a primary display, the smartphone 132 could provide content that complements primary content shown by an application on a primary display coupled to the game console 110. The smartphone 132 could provide a control surface for one or more applications on the game console 110.

The headset 136 captures audio input from a player and the player's surroundings and may also act as an output device if it is coupled with a headphone or other speaker. In one aspect, the headset 136 is a wireless headset.

Application service 130 may comprise multiple computing devices communicatively coupled to each other in one or more data centers. The application service 130 can connect to the network 120 via a router that facilitates the network 120. In an aspect, the application service 130 can generate event requests on behalf of applications installed on a device.

The monitoring environment 100 illustrates the type of connections that could be monitored by aspects of the present technology. For example, the game console 110 may utilize a monitoring application to notify one or more other applications on the game console 110 when a peripheral device forms a connection with the game console 110. For example, a game application running on the game console 110 may choose to present secondary content through a smartphone, such as smartphone 132, when the smartphone 132 is connected to the game console 110. The connection could be a Bluetooth® connection, a Wi-Fi Direct® connection, or a connection through the local area network 120. The monitoring application on the game console 110 may monitor activity at one or more radios or network connections, such as an Ethernet port, to detect a monitored event, such as a connection or disconnection. Upon determining that the smartphone 132 has formed a connection with the game console 110, the monitoring application can notify the game application that the smartphone 132 is connected.

The game application may then choose to initiate communications with one or more applications on the smartphone 132. The game application does not need to directly monitor the game console for relevant events. For example, the game application may provide game state information to an application on the smartphone 132 that displays secondary content related to the game on the smartphone 132. In another aspect, the game application could use the smartphone 132 as an input device, for example, using the touchscreen to move a mouse or a touch keyboard to input text.

In another aspect, the tablet 112 may include a monitoring application that determines when it is communicatively coupled to the personal computer 114. The monitoring application may notify an inactive photo application that the device is communicatively coupled to the personal computer. While in an inactive state, an application is not running any active process threads. Various inactive states are possible. In one aspect, an inactive computing application has code resident on the tablet 112, for example, in long term memory, but is not running or loaded into active memory. The notification can include an instruction to activate the application. Upon receiving a notification from the monitoring application, the photo application can initiate to an active state, including a background state. A background state allows the application to provide various functionalities but does not cause the application to generate a user interface for display on the device. In an active state, an application is loaded into active memory. The photo application may then communicate with a corresponding application on the PC 114, for example, to communicate recent photographs to the PC 114.

In another aspect, a router that generates network 120, such as a wireless router in a person's home, is the component being monitored for an event. For example, when the tablet 112 connects to the wireless router that facilitates network 120, then a monitoring application can notify one or more applications on the tablet 112 that a connection has been established with the router. A user may set preferences on one or more applications to synchronize data, receive updates, or perform other tasks that include the desire to transfer data only when the user is connected to a known network. In other words, the user may not want to use a friend's network or a work network to synchronize photos, music, or other data between an Internet resource and the device. Instead, the user device can be set to only transmit this data when connected to a home network. The various applications that wish to send or receive data when connected can provide a request to the monitoring application to provide a notification when the user is connected to a particular network.

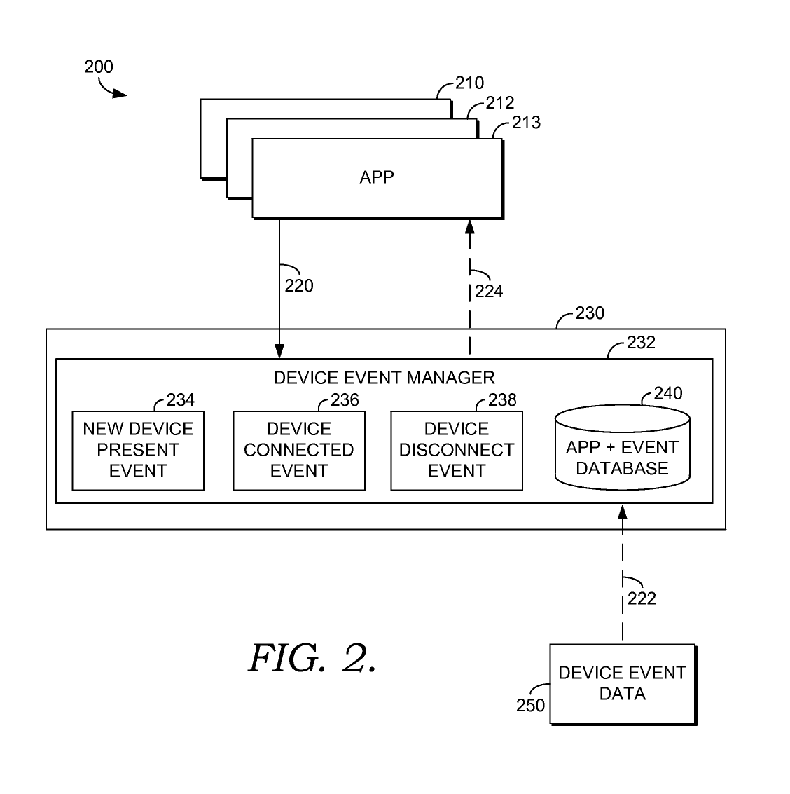

Turning now to FIG. 2, a device status environment 200 is shown, in accordance with an aspect of the technology described herein. Environment 200 can exist entirely on a single user device. The device status environment 200 includes a first application 210, a second application 212, and a third application 213. Each of these applications are installed on a user device. The applications can register a request to monitor the status of external devices, such as a computing device or router. The device event manager 232 can provide one or more application program interfaces 230 through which requests can be communicated to the device event manager 232. Similarly, a set of APIs can receive device event data 250. Other APIs can communicate notifications to the various applications, wake up applications, or initiate an application.

An application can communicate a monitoring request 220 to the device event manager 232. The request 220 can specify a particular device or a class of device to be monitored for the presence of a specific communication status. The request 220 can also specify a particular type of device status event that should trigger a notification. For example, the request 220 can specify that an application receive a notification when the user device connects (type of event) with a specific tablet (specific device). The device event manager 232 can store the request 220 in the event database 240. The meaning of “storing the request” can include only storing information from the request needed to perform monitoring.

The device event manager 232 can then monitor device event data 250 on the user device. Various components of the user device, including hardware components and software components, can communicate 222 device event data 250 to the device event manager 232. The device event data 250 can be interpreted by various event handlers to determine when an event that complies with a status request has occurred. Connections, which may be described herein as relationships, can be monitored across multiple protocols and communication methods including but not limited to: physically connected busses like PCI and USB, UPnP, DLNA, DIAL, DNS-SD, Web Services on Devices (WSD), Bluetooth® and BluetoothLE, Wi-Fi Direct®, WiGig, Wi-Fi, and Point of service.

The new-device-present event handler 234 can determine when a device matching a request is first present or in proximity to a user device. The new-device-present event handler 234 can generate a notification when a known or unknown device is first detected to be proximate to the user device. The proximity can be detected when the user device connects to a common local area network or when wireless signals from the user device are detected. A device can be present when it is in physical proximity, but not connected to the user device. For example, an external device could have connected to the same network as a user device, but not yet connected to the user device over the network. For example, a signal associated with a router could indicate that the router is nearby even when the end user device has not connected to the router. Similarly, Bluetooth® and Wi-Fi signals emitted by various computing devices can be monitored to determine when the end user device is in proximity to the device emitting the wireless signal. Upon determining that an external device is present, a notification 224 can be communicated to the application that made the request to monitor for such an event. The notification 224 can communicate that the external device is now present. A presence event can specify a signal strength or other proxy for closeness to the user device. For example, the presence events may specify a threshold Wi-Fi signal strength required to satisfy the event.

The notification 224 can be sent to the application while the application is in various states, including an inactive state and an active state. Different platforms may use different terms to describe these states and intermediary states are possible, such as a loading and closing state. For example, the inactive state may be described alternatively as a sleep state or dormant state. The inactive state describes an application that is not running in active memory on the computing device. For example, an inactive application may have all process threads frozen by the operating system. Alternatively, an inactive application could have code stored on the client device, but the program has is not opened. When a receiving application is inactive, prior to sending a notification, the receiving program can be transitioned to an active state by the monitoring application.

An active state describes an application running in active memory with one or more active process threads. One type of active state is a background state. The background state describes an application that is running in active memory, but is not generating a user interface. A background state allows the application to provide various functionalities, but does not cause the application to generate a user interface for display on the device. In one aspect, causing a notification to be generated in a notification bar is not considered an active user interface.

In one aspect, an application capable of receiving digital ink sends a request to the monitoring application to provide a notification any time an active pen is present. Upon receiving a notification that an active pen is present, the application generates a user interface feature asking the user whether he wants to use the active pen as an input mechanism.

The device-connected event handler 236 determines when a device is connected to the user device. Upon determining that the connected device is associated with a request in the event database 240, a notification 224 is communicated to the appropriate application. The connection could be a wireless connection or a wired connection, for example, through a USB cable. The wired connection could be a direct connection or through a network router. In one aspect, the technology described herein is limited to use with local area networks. The connection could be physically connected, remotable over the Internet, through a LAN a PAN or some other wireless connection.

The device-disconnect event handler 238 determines when a computing device disconnects from the user device. The disconnection could be physically disconnected and no longer remotable over the Internet, for example because one of the devices lost a network connection. For example, a user could move a user device outside of the range of a Wi-Fi network at which time the user device will disconnect from the network. Alternatively, a nearby device could be powered off. This could also trigger a device disconnect event. The device-disconnect event handler 238 could generate a notification 224 indicating that the user device is no longer connected to the Wi-Fi network. The notification can be sent to any application that requested a notification upon the detection of a disconnect event for the device or class of device associated with the event.

The applications may periodically add or subtract devices or device classes to be monitored. The devices can be monitored according to device class. For example, an application may want to receive a notification any time the user is in proximity to a Wi-Fi router. Each time the presence of a Wi-Fi network is detected, the application could receive a notification. In another instance, the application is only interested in specific Wi-Fi networks. In this case, the notification or request 220 could specify a specific Wi-Fi network, by name, or other identifying information. Similarly, unique device information or identifiers associated with individual smartphones, tablets, personal computers, televisions, game consoles, and other devices can be used to specifically identify a particular device to be associated with an event.

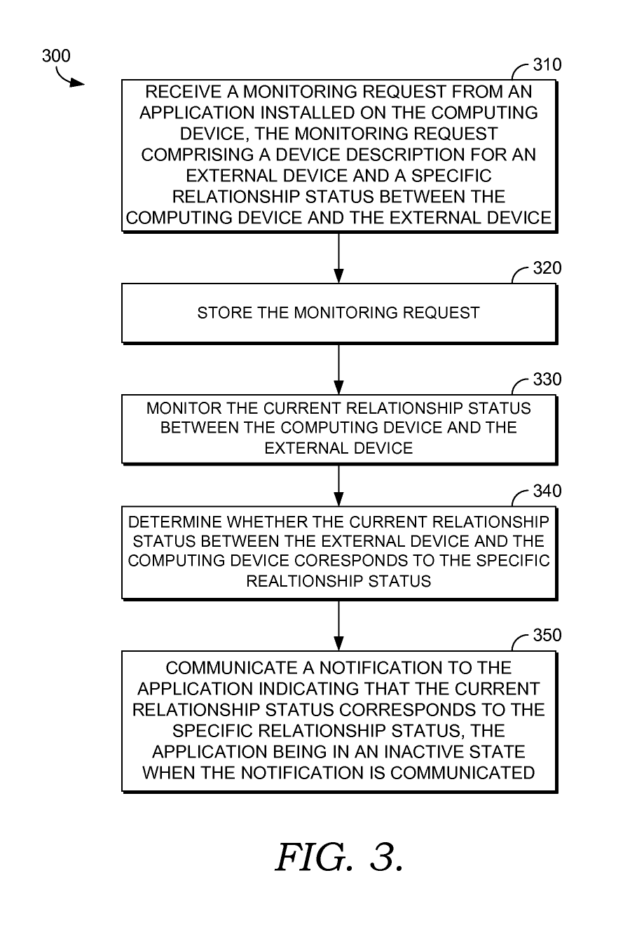

Turning now to FIG. 3, a method 300 of monitoring an external device status on behalf of multiple applications installed on the computing device is provided, in accordance with an aspect of the technology described herein. Method 300 could be performed on a computing device such as a smartphone, a tablet, a laptop, augmented reality glasses, game console, and such. In one aspect, method 300 is performed by a monitoring application, such as device event manager 232 described previously, running on the computing device. In one aspect, applications running on the computing device do not separately monitor a relationship between the computing device and other devices.

At step 310, a monitoring request is received from an application installed on the computing device. The monitoring request comprises a device description for an external device to monitor. The monitoring request also comprising a specific relationship status between the computing device and the external device. The device description can be for a specific device, such as the user smartphone. The device description could also be for a class of devices, such as any smartphone. A single application can generate multiple monitoring requests.

The specific relationship status can include a connection event, such as the computing device forming a communication connection with a smartphone. The communication connection can be a wireless connection or a wired connection. The relationship status can also include a disconnection event, such as the computing device disconnecting from a smartphone. The disconnection could occur when the smartphone powers off, turns off its radio, disconnects physically from a USB attachment of the computing device, or leaves the range of a wireless network to which the computing device is connected. Other disconnection scenarios are possible. The relationship status can also include a proximity event. The proximity event occurs when the computing device detects the external device, but a communication connection is not yet formed. For example, a wireless signal emitted by the external device could be detected.

At step 320, the monitoring request is stored in computer storage, such as a monitoring log database. Storing the monitoring request can include storing the only the relevant information from the monitoring request. For example, the actual request need not be stored, but the specific relationship status, the specific device, and the requesting application could all be stored to facilitate monitoring and notification. The combination of the specific relationship status and the device description can be called a trigger criterion herein. Accordingly, the trigger criterion can be stored in the monitoring log.

At step 330, the current relationship status between the computing device and the external device is monitored. The monitoring application can evaluate external device data received from various sources against the monitoring request. The monitoring application can maintain the relationship status for multiple external devices. When a relationship status changes, the change can be compared against monitoring request to determine whether a notification should be sent to an application associated with the request. An individual application can request notifications for multiple scenarios. For example, an application could request a notification upon a connection event with a particular device and upon a disconnect event with the same device.

At step 340, the current relationship status between the external device and the computing device is determined to correspond with the specific relationship status. At step 350, based at least on the determination that the current relationship status corresponds to the specific relationship status, a notification is communicated to the application indicating that the current relationship status corresponds to the specific relationship status. In one aspect, the application is in an inactive state when the notification is communicated. In one aspect, the application is not actively monitoring the current connection status.

An inactive state means that the application is not running in active memory on the computing device. For example, the application could be loaded in active memory, but all processing threads associated with the application could be frozen. As part of the notification process, an instance of the application may be activated in order to receive or act on the notification. The notification can include an instruction that causes the application to be loaded into active memory and run. Alternatively, a function to activate the application can called when sending the notification. A request to activate an inactive application can be included in the monitoring request information received from the application, and stored in the monitoring log. In one aspect, an application only receives a notification when the application is already running on the computing device, meaning the receiving application can be activated prior to communicating the notification. In one aspect, an inactive application is activated to a background state. In a background state, various functions can be performed by the application, but a user interface is not provided by the application.

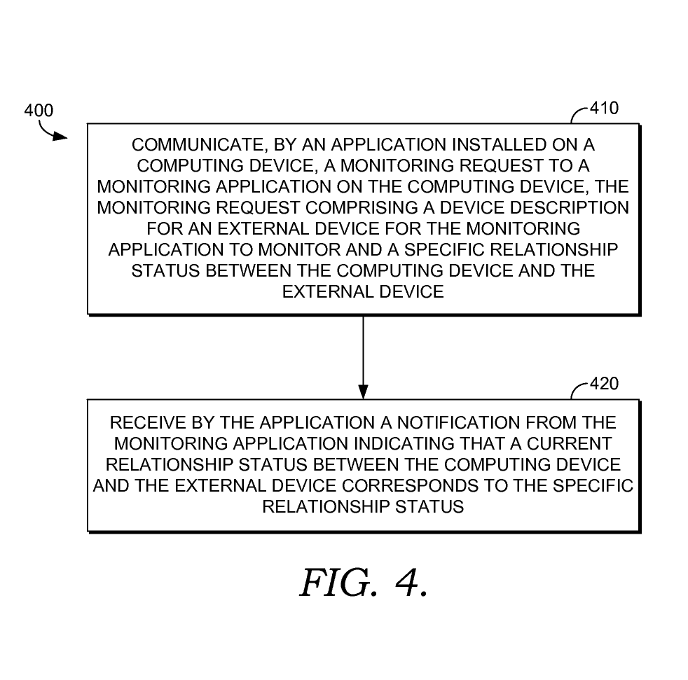

Turning now to FIG. 4, a method 400 of monitoring an external device status is provided, in accordance with an aspect of the technology described herein. Method 400 may be performed by an application that wishes to have the relationship between a computing device and one or more external devices monitored on its behalf.

At step 410, a monitoring request is communicated to a monitoring application on the computing device. The monitoring request comprises a device description for an external device for the monitoring application to monitor and a specific relationship status between the computing device and the external device. The monitoring request may be communicated through an API provided by a monitoring application, such as device event manager 232 described previously. The combination of the specific relationship status and the device description can be called a trigger criterion herein.

As mentioned, the monitoring request comprises a device description for an external device to monitor. The device description can be for a specific device, such as the user smartphone. The device description could also be for a class of devices, such as any smartphone. A single application can generate multiple monitoring requests.

The specific relationship status can include a connection event, such as the computing device forming a communication connection with a smartphone. In another example, the connection event is an indication that the external device is presently online and can receive communications. The communication connection can be a wireless connection or a wired connection. The relationship status can also include a disconnection event, such as the computing device disconnecting from a smartphone. The disconnection could occur when the smartphone powers off, turns off its radio, disconnects physically from a USB attachment of the computing device, or leaves the range of a wireless network to which the computing device is connected. Other disconnection scenarios are possible. The relationship status can also include a proximity event. The proximity event occurs when the computing device detects the external device, but a communication connection is not yet formed. For example, a wireless signal emitted by the external device could be detected.

At step 420, when the application is in an inactive state, a notification is received by the application. The notification from the monitoring application can indicate that a current relationship status between the computing device and the external device corresponds to the specific relationship status.

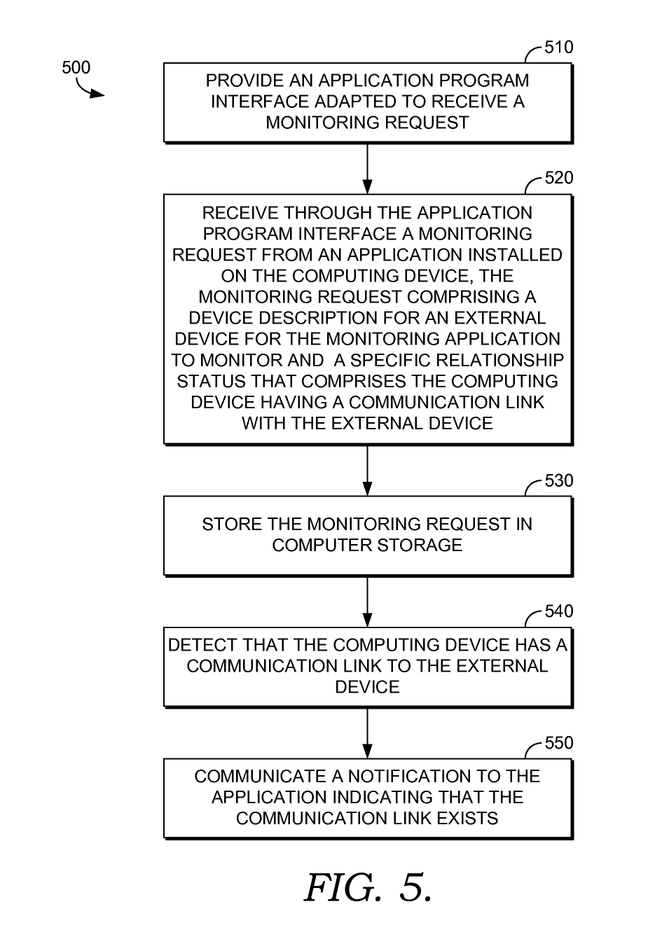

Turning now to FIG. 5, a method 500 of monitoring an external device status on behalf of an application installed on the computing device is provided, in accordance with the technology described herein.

At step 510, an application program interface (API) adapted to receive a monitoring request is provided. The API can be for a particular type of monitoring request, for a particular type of application, or for a particular type of device to be monitored. The API can comprise one or more defined functions that allow the application to define variables associated with the monitoring request. For example, the API can allow the application to define a device variable in a relationship variable. The device description can be for a specific device, such as the user smartphone. The device description could also be for a class of devices, such as any smartphone. A single application can generate multiple monitoring requests.

The relationship status can include a connection event, such as the computing device forming a communication connection with a smartphone. The communication connection can be a wireless connection or a wired connection. The relationship status can also include a disconnection event, such as the computing device disconnecting from a smartphone. The disconnection could occur when the smartphone powers off, turns off its radio, disconnects physically from a USB attachment of the computing device, or leaves the range of a wireless network to which the computing device is connected. Other disconnection scenarios are possible. The relationship status can also include a proximity event. The proximity event occurs when the computing device detects the external device, but a communication connection is not yet formed. For example, a wireless signal emitted by the external device could be detected.

At step 520, a monitoring request from an application installed on the computing device is received through the application program interface. The monitoring request comprises a device description for an external device for the monitoring application to monitor. The monitoring request also comprises a specific relationship status that comprises the computing device having a communication link with the external device. The communication link could be detected when originally formed. In one aspect, monitoring requests are received from multiple applications on the computing device.

At step 530, the monitoring request is stored in computer storage. The monitoring request can be associated with the application that made the request. In one aspect, the computer storage can store monitoring requests received from multiple applications.

At step 540, the computing device is detected to have a communication link to the external device. Having the communication link with the external device specified in the monitoring request satisfies the monitoring request.

At step 550, a notification indicating that the communication link exists is communicated to the application. The notification is communicated in response to the determination made at step 540. The notification can comprise an instruction to activate the application, if the application in an inactive state. The instruction to active the application can also be sent to other components of the computing device configured to activate the application.

### Exemplary Operating Environment

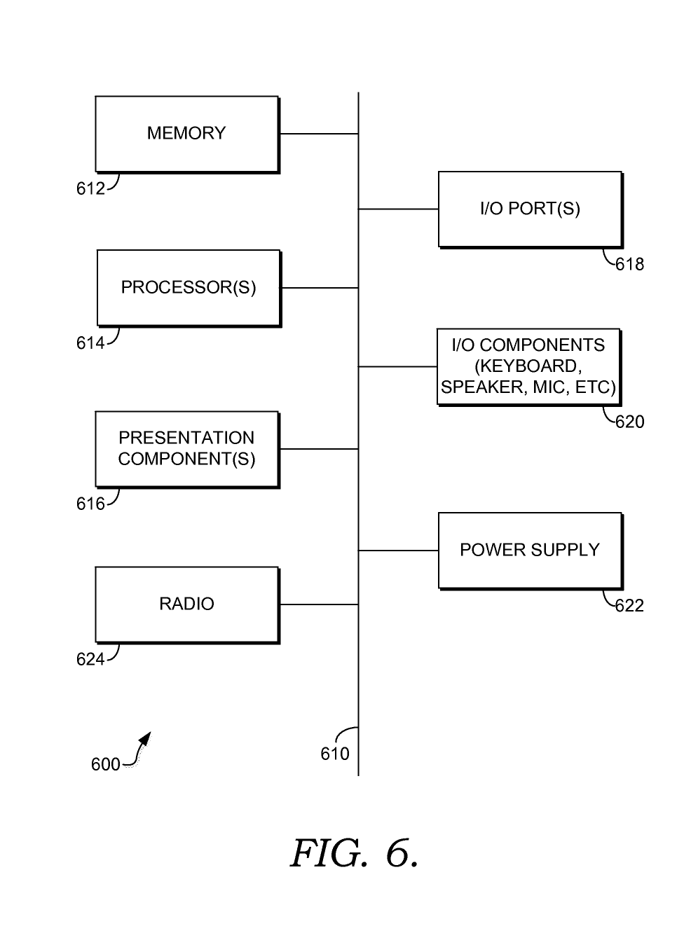

Referring to the drawings in general, and initially to FIG. 6 in particular, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 6 and refer to “computer” or “computing device.” The computing device 600 may be a PC, a tablet, a smartphone, virtual reality headwear, augmented reality headwear, a game console, and such.

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, optical-disc drives, etc. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, vibrating component, etc. I/O ports 618 allow computing device 600 to be logically coupled to other devices, including I/O components 620, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separate from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

The computing device 600 may include a radio 624. The radio transmits and receives radio communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth® connection to another computing device is a second example of a short-range connection. A long-range connection may include a connection using one or more of CDMA, GPRS, GSM, TDMA, and 802.16 protocols.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A computing device comprising:
at least one processor; and
memory having computer-executable instructions stored thereon that, based on execution by the at least one processor, configure the at least one processor to monitor an external device status on behalf of multiple applications installed on the computing device by being configured to:
receive a monitoring request from an application installed on the computing device, the monitoring request comprising a device description for an external device and a specific relationship status between the computing device and the external device;
monitor a current relationship status between the computing device and the external device;
determine whether the current relationship status corresponds to the specific relationship status; and
based at least on the determination that the current relationship status corresponds to the specific relationship status, communicate a notification to the application indicating that the current relationship status corresponds to the specific relationship status, the application being in an inactive state when the notification is communicated.

2. The computing device of claim 1, wherein the specific relationship status is one of nearby, connected to the computing device, or disconnected from the computing device.

3. The computing device of claim 1, wherein the device description comprises a device type.

4. The computing device of claim 3, wherein the device type is an active stylus.

5. The computing device of claim 1, wherein the notification is only communicated when the current relationship status changes to correspond to the specific relationship status.

6. The computing device of claim 1, wherein the processor is further configured to cause the application to be transitioned from the inactive state to an active state upon said the current relationship status corresponds to the specific relationship status.

7. The computing device of claim 6, wherein the active state is a background state, wherein the application running in the background state does not have a user interface actively displayed on a display component associated with the computing device.

8. The computing device of claim 1, wherein the inactive state comprises all processing threads of the application being frozen.

9. A method of monitoring an external device status comprising:
communicating, by an application installed on a computing device, a monitoring request to a monitoring application on the computing device, the monitoring request comprising a device description for an external device for the monitoring application to monitor and a specific relationship status between the computing device and the external device; and
receiving by the application a notification from the monitoring application indicating that a current relationship status between the computing device and the external device corresponds to the specific relationship status.

10. The method of claim 9, wherein the specific relationship status is one of nearby, connected to the computing device, physically connected, remotable over the Internet, or disconnected from the computing device.

11. The method of claim 9, wherein the device description comprises a specific external device.

12. The method of claim 11, wherein the specific external device is a known wireless router.

13. A method of claim 9, wherein the device description comprises a device type.

14. The method of claim 9, wherein the method further comprises transitioning the application from an inactive state to an active state upon said receiving of the notification.

15. The method of claim 14, wherein the active state is a background state in which state a user interface is not generated by the application.

16. A method of monitoring an external device status on behalf of an application installed on a computing device, the method comprising:
providing an application program interface adapted to receive a monitoring request;
receiving through the application program interface the monitoring request from the application installed on the computing device, the monitoring request comprising a device description for an external device and a specific relationship status that comprises the computing device having a communication link with the external device;
detecting that the computing device has the communication link to the external device; and
upon said detecting, communicating a notification to the application indicating that the communication link exists.

17. The method of claim 16, wherein the application is a digital ink enabled application and the external device is an active pen.

18. The method of claim 16, wherein the external device is an automobile.

19. The method of claim 16, wherein the method further comprises activating the application prior to communicating said notification.

20. The method of claim 16, wherein the external device is a specific wireless router.
